(19) United States
(12) Patent Application Publication
(10) Pub. No.: US 2026/0251085 A1
(43) Pub. Date: Aug. 27, 2026

(54) EXHAUST MANIFOLD AND ENGINE

(71) Applicant: Yanmar Holdings Co., Ltd., Osaka (JP)

(72) Inventors: Issei OHASHI, Osaka (JP); Koichi HIROSE, Osaka (JP)

(73) Assignee: Yanmar Holdings Co., Ltd., Osaka (JP)

(21) Appl. No.: 19/436,448

(22) Filed: Dec. 30, 2025

(30) Foreign Application Priority Data
Jan. 6, 2025 (JP) 2025-000087

(51) Int. Cl. F01N 13/10

(52) U.S. Cl. CPC F01N 13/10

(57) ABSTRACT

An exhaust manifold of an engine including a plurality of cylinders includes: a plurality of exhaust pipes through each of which an exhaust gas discharged from each of the cylinders flows; and a joining pipe coupled to the plurality of exhaust pipes, to which the exhaust gas flowing through each of the exhaust pipes is joined. The joining pipe includes a plurality of guide portions provided to respectively correspond to the plurality of exhaust pipes. Each of the guide portions guides the exhaust gas flowing in from the corresponding exhaust pipe in a flow direction of the exhaust gas flowing through the joining pipe, and has an opposing surface provided to be opposed to an outlet of the corresponding exhaust pipe. At least one of the guide portions has a part that is disposed on a downstream side in the flow direction with respect to the outlet.

### TECHNICAL FIELD

The present invention relates to an exhaust manifold and an engine.

### BACKGROUND ART

Patent Document 1 discloses an exhaust manifold of a three-cylinder engine, which includes a main pipe and three exhaust inlet pipes branching from the main pipe. Outlet ports of two exhaust inlet pipes out of the three exhaust inlet pipes are curved and tilted toward an exhaust outlet opening at a left end portion of the main pipe.

### PRIOR ART DOCUMENT

### Patent Document

Patent Document 1: JP05-89832 U

### SUMMARY OF INVENTION

### Technical Problem

Even in a case in which the exhaust inlet pipes (exhaust pipes) are curved and tilted as in Patent Document 1, particularly when its tilting degree is small, an exhaust gas that has passed through the exhaust inlet pipe is joined while greatly tilting with respect to a flow direction of an exhaust gas flowing through the main pipe (joining pipe). In this case, flow disturbance occurs at a jointing portion of the exhaust gas. This flow disturbance hinders discharge of the exhaust gas from the exhaust inlet pipe to the main pipe. As a result, the exhaust gas is less liable to be discharged from each cylinder of the engine, and there is a fear in that thermal efficiency of the engine is reduced.

The present invention has been made to solve the above-mentioned problem, and has an object to provide a technology capable of suppressing flow disturbance caused at the time of joining of an exhaust gas, improving thermal efficiency of an engine, and enhancing cleanliness of the exhaust gas.

### Solution to Problem

An exhaust manifold according to one aspect of the present invention is an exhaust manifold of an engine including a plurality of cylinders, the exhaust manifold including: a plurality of exhaust pipes through each of which an exhaust gas discharged from each of the cylinders flows; and a joining pipe coupled to the plurality of exhaust pipes, to which the exhaust gas flowing through each of the exhaust pipes is joined. The joining pipe includes a plurality of guide portions provided to respectively correspond to the plurality of exhaust pipes. Each of the guide portions guides the exhaust gas flowing in from the corresponding exhaust pipe in a flow direction of the exhaust gas flowing through the joining pipe. Each of the guide portions has an opposing surface provided to be opposed to an outlet of the corresponding exhaust pipe. At least one of the guide portions has a part that is disposed on a downstream side in the flow direction with respect to the outlet.

An engine according to another aspect of the present invention includes a plurality of cylinders and the above-mentioned exhaust manifold.

### Advantageous Effects of Invention

With the above-mentioned configuration, it is possible to suppress the flow disturbance caused at the time of joining of the exhaust gas, improve the thermal efficiency of the engine, and enhance the cleanliness of the exhaust gas.

### BRIEF DESCRIPTION OF DRAWINGS

FIG. 1 is an explanatory view schematically illustrating a schematic configuration of an engine according to one embodiment of the present invention;

FIG. 2 is a side view illustrating a configuration of an exhaust manifold of the above-mentioned engine;

FIG. 3 is a front view illustrating the configuration of the above-mentioned exhaust manifold;

FIG. 4 is a sectional view of the above-mentioned exhaust manifold;

FIG. 5 is a sectional view of the above-mentioned exhaust manifold; and

FIG. 6 is a sectional view of a modification example of the above-mentioned exhaust manifold.

### DESCRIPTION OF EMBODIMENTS

Embodiments of the present invention are described below with reference to the drawings.

### 1. Schematic Configuration of Engine

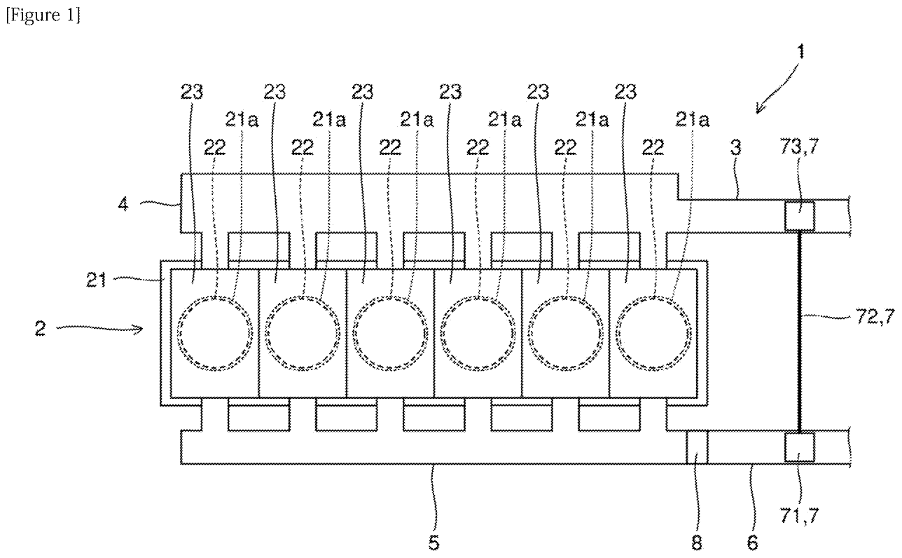

FIG. 1 is an explanatory view schematically illustrating a schematic configuration of an engine 1 according to one embodiment of the present invention. The engine 1 is mounted on, for example, an agricultural machine such as a tractor or a combine. However, the engine 1 may be mounted on a construction machine such as a hydraulic excavator or a wheel loader, or may be mounted on a vessel. Further, the engine 1 may be used in a stationary power generation device.

Here, directions in the present embodiment are defined as follows. One side in a direction in which a plurality of exhaust manifold members 51 of an exhaust manifold 5 are arranged is defined as “front”, and the other side is defined as “back”. Further, when the exhaust manifold 5 is viewed from backward, the left side is defined as “left”, and the right side is defined as “right”. Moreover, the gravity direction perpendicular to a front-back direction and a right-left direction is defined as an up-down direction, and an upstream side in the gravity direction is defined as “up” and a downstream side thereof is defined as “down”. In the drawings, as required, forward is denoted by a symbol “F”, likewise, backward by “B”, leftward by “L”, rightward by “R”, upward by “U”, downward by “D”, leftward and upward by “LU”, leftward and downward by “LD”, rightward and upward by “RU”, and rightward and downward by “RD”.

The engine 1 includes an engine main body 2, an intake pipe 3, an intake manifold 4, an exhaust manifold 5, a discharge pipe 6, and a turbocharger 7. The engine main body 2 includes a cylinder block 21, pistons 22, and cylinder heads 23.

The cylinder block 21 is configured of a metal member having a cuboid shape extending in the front-back direction. To a lower portion of the cylinder block 21, an oil pan (not shown) that stores lubricating oil to be used for lubrication of each portion of the engine main body 2 is coupled.

In the cylinder block 21, a cylinder 21a having a cylindrical shape extending in the up-down direction is formed. The cylinder 21a extends downward from an upper surface portion of the cylinder block 21, and six cylinders 21a are provided side by side in the front-back direction. However, the number of cylinders 21a is not limited to six, and may be, for example, plural other than six. That is, the engine 1 includes a plurality of cylinders 21a.

In each cylinder 21a, the piston 22 configured of a columnar metal member is accommodated to be slidable in the up-down direction in each cylinder 21a. The cylinder head 23 is disposed above each cylinder 21a. That is, in the present embodiment, six pistons 22 and six cylinder heads 23 are provided.

Each cylinder head 23 is configured of a metal member having a cuboid shape. In each cylinder head 23, an intake port (not shown) for supplying intake air to a combustion chamber and an exhaust port (not shown) for discharging an exhaust gas from the combustion chamber are formed. The above-mentioned combustion chamber means a space surrounded by an inner peripheral surface of the cylinder 21a, a top surface of the piston 22, and a bottom surface of the cylinder head 23.

In the combustion chamber, fuel is ejected at a predetermined timing. In the present embodiment, the above-mentioned fuel is light oil. However, the fuel is not limited to light oil, and may be, for example, heavy oil, biofuel, or gaseous fuels such as a hydrogen gas. A force generated by combustion of fuel ejected to the combustion chamber causes the piston 22 to perform a reciprocating motion. This reciprocating motion of the piston 22 is converted into a rotational motion by a crankshaft (not shown) disposed rotatable inside the cylinder block 21 while being coupled to each piston 22. This makes it possible to extract power from the engine 1 to the outside. That is, the above-mentioned crankshaft is provided to extract power of the engine 1.

The intake pipe 3 takes in air from the outside to supply the air to the intake manifold 4. The intake manifold 4 supplies the air (intake air) supplied from the intake pipe 3 to each combustion chamber (each cylinder 21a) via the intake port of each cylinder head 23.

The exhaust manifold 5 collectively discharges the exhaust gas discharged from each combustion chamber via the exhaust port of the cylinder head 23 to the discharge pipe 6. The discharge pipe 6 discharges the exhaust gas collected in the exhaust manifold 5 to the outside of the engine 1.

A turbine 71 is provided to the discharge pipe 6. The turbine 71 is coupled to a compressor 73 via a coupling shaft 72. The compressor 73 is provided to the intake pipe 3. The turbine 71, the coupling shaft 72, and the compressor 73 configure the turbocharger 7. The turbine 71 rotates when the exhaust gas flowing through the discharge pipe 6 hits the turbine 71. The compressor 73 is driven by the rotational power of the turbine 71 transmitted via the coupling shaft 72 to compress the intake air. Thus, the turbocharger 7 makes it possible to increase an amount of intake air to be supplied to each combustion chamber (each cylinder 21a). It is to be noted that the engine 1 may have a configuration excluding the turbocharger 7. Further, the engine 1 may have a configuration including a supercharging mechanism other than the turbocharger 7 in place of the turbocharger 7.

The intake manifold 4 is attached on the left side of the engine main body 2, and the exhaust manifold 5 is attached on the right side of the engine main body 2. However, the intake manifold 4 may be attached on the right side of the engine main body 2, and the exhaust manifold 5 may be attached on the left side of the engine main body 2. Further, at least one of the intake manifold 4 and the exhaust manifold 5 may be attached on the upper side of the engine main body 2. Hereinafter, the configuration of the exhaust manifold 5 is described.

### 2. Configuration of Exhaust Manifold

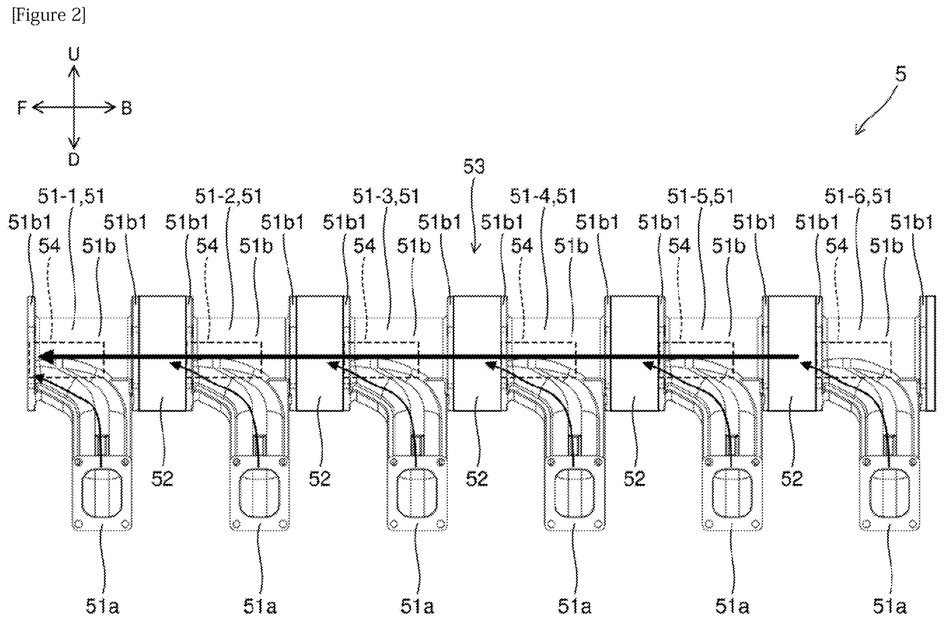

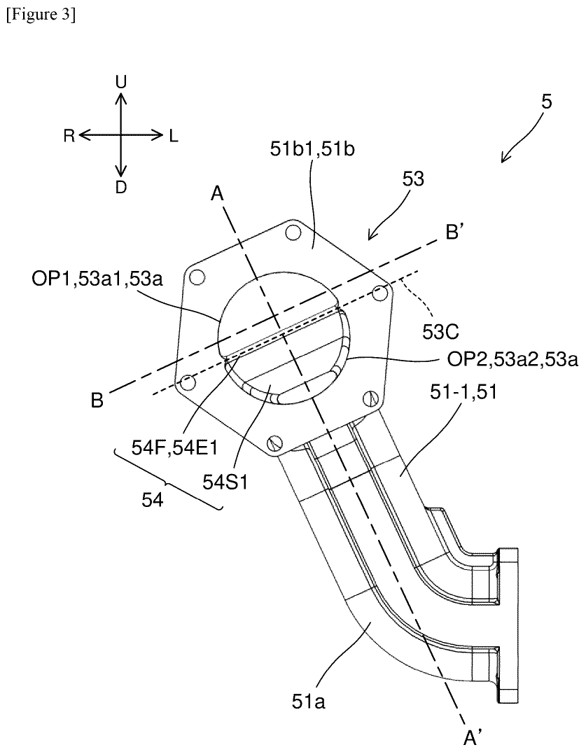

FIG. 2 and FIG. 3 are a side view and a front view illustrating the configuration of the exhaust manifold 5. The exhaust manifold 5 includes a plurality of exhaust manifold members 51 and a plurality of coupling pipes 52. The plurality of exhaust manifold members 51 are provided to respectively correspond to the plurality of cylinders 21a (see FIG. 1). That is, in the present embodiment, six exhaust manifold members 51 are provided.

The plurality of exhaust manifold members 51 have the same configuration. However, some exhaust manifold members 51 may have a configuration different from that of the exhaust manifold members 51 other than some exhaust manifold members 51 (the remaining exhaust manifold members 51). Further, the plurality of exhaust manifold members 51 may have different configurations.

The plurality of exhaust manifold members 51 are disposed side by side in the front-back direction. In particular, each exhaust manifold member 51 is disposed on the right side of the cylinder head 23 (see FIG. 1) positioned above the corresponding cylinder 21a.

Here, when the six exhaust manifold members 51 are particularly distinguished, those are called, from the front side to the back side, a first exhaust manifold member 51-1, a second exhaust manifold member 51-2, a third exhaust manifold member 51-3, a fourth exhaust manifold member 51-4, a fifth exhaust manifold member 51-5, and a sixth exhaust manifold member 51-6.

Adjacent exhaust manifold members 51 are coupled via the coupling pipe 52. The coupling between the coupling pipe 52 and the exhaust manifold member 51 is achieved by using a fastening member such as a bolt. It is to be noted that, when the above-mentioned fastening member is removed, the coupling between the coupling pipe 52 and the exhaust manifold member 51 is canceled. Thus, the exhaust manifold 5 of the present embodiment is configured to be divisible.

The coupling pipe 52 is provided to prevent the exhaust manifold 5 from being damaged by thermal expansion of each exhaust manifold member 51. Each coupling pipe 52 is configured of, for example, an elastically deformable bellows-shaped pipe member. However, for example, when the degree of thermal expansion of each exhaust manifold member 51 is small, each coupling pipe 52 may be configured to be non-elastically-deformable, or adjacent exhaust manifold members 51 may be directly coupled to each other.

It is to be noted that the sixth exhaust manifold member 51-6 has a closed end portion on a side opposite to the side coupled to the adjacent fifth exhaust manifold member 51-5. Further, the exhaust manifold 5 is coupled to the discharge pipe 6 via a joint member 8 that is a component similar to the coupling pipe 52 (see FIG. 1). In detail, the joint member 8 couples the first exhaust manifold member 51-1 and the discharge pipe 6.

Each exhaust manifold member 51 is configured to integrally include an exhaust pipe 51a and a flow pipe 51b. That is, the engine 1 includes a plurality of (in the present embodiment, six) exhaust pipes 51a. The exhaust pipe 51a has one end portion connected to the cylinder head 23, and another end portion connected to the flow pipe 51b. In more detail, the exhaust pipe 51a extends out rightward from the cylinder head 23, bends obliquely upward, and intersects with the flow pipe 51b. That is, the exhaust pipe 51a has a part extending rightward and upward toward the flow pipe 51b. In particular, connection between the exhaust pipe 51a and the cylinder head 23 is established so that the inside of the exhaust pipe 51a and the exhaust port of the cylinder head 23 communicate with each other. The exhaust pipe 51a is formed into a rectangular tube shape. However, the exhaust pipe 51a is not limited to the above-mentioned configuration, and may be formed into, for example, a circular tube shape or an oval tube shape.

As described above, the plurality of exhaust manifold members 51 have the same configuration and are disposed side by side in the front-back direction. Thus, the plurality of exhaust pipes 51a have the same configuration (configuration of extending out rightward from the cylinder head 23 and bending obliquely upward), and are positioned side by side in the front-back direction. That is, each exhaust pipe 51a is disposed in the same orientation (right-left orientation in the present embodiment).

When a case in which the plurality of exhaust pipes 51a are disposed in the same orientation and a case in which the plurality of exhaust pipes 51a are disposed in different orientations are compared, a simpler shape can be obtained when the plurality of exhaust pipes 51a are disposed in the same orientation, and hence the exhaust manifold 5 can be manufactured easier. Thus, from the viewpoint of easily manufacturing the exhaust manifold 5, as in the present embodiment, each exhaust pipe 51a is desirably disposed in the same orientation (right-left orientation in the present embodiment).

The flow pipe 51b is formed to extend in the front-back direction. The flow pipe 51b is formed into a circular tube shape. However, the flow pipe 51b is not limited to the above-mentioned configuration, and may be formed into, for example, an oval tube shape or a rectangular tube shape. A flange portion 51b1 is provided at each of a front end portion and a back end portion of the flow pipe 51b. The flange portion 51b1 is provided to easily couple the exhaust manifold member 51 and the coupling pipe 52 or the joint member 8.

In the present embodiment, the flow pipes 51b of the respective exhaust manifold members 51 and the plurality of coupling pipes 52 are collectively called a joining pipe 53. That is, the engine 1 includes the joining pipe 53, and this joining pipe 53 is coupled to the plurality of exhaust pipes 51a.

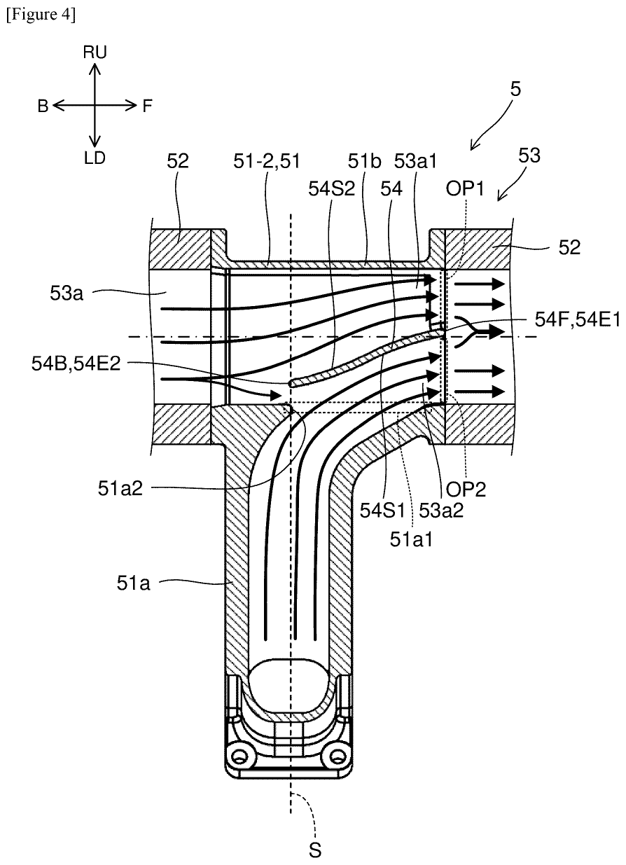

An exhaust gas discharged from each combustion chamber (each cylinder 21a) flows into the corresponding exhaust pipe 51a via the exhaust port of the corresponding cylinder head 23. The exhaust gas that has flowed into the exhaust pipe 51a flows through the exhaust pipe 51a toward the flow pipe 51b (see also FIG. 4 referred to later). That is, an exhaust gas discharged from each cylinder 21a flows through the plurality of exhaust pipes 51a. The exhaust gas that has passed through each exhaust pipe 51a flows into the joining pipe 53 (flow pipe 51b).

Each exhaust gas that has flowed into the joining pipe 53 collectively flows toward the discharge pipe 6. For example, an exhaust gas that has passed in order through the exhaust pipe 51a and the flow pipe 51b of the sixth exhaust manifold member 51-6 flows into the flow pipe 51b of the fifth exhaust manifold member 51-5. In detail, the above-mentioned inflow is performed via the coupling pipe 52 coupling between the sixth exhaust manifold member 51-6 and the fifth exhaust manifold member 51-5. The exhaust gas that has passed through the exhaust pipe 51a of the fifth exhaust manifold member 51-5 joins the exhaust gas flowing through the flow pipe 51b of the fifth exhaust manifold member 51-5 (from the sixth exhaust manifold member 51-6), and flows into the flow pipe 51b of the fourth exhaust manifold member 51-4. Such joining of the exhaust gas makes it possible to cause each exhaust gas that has flowed into the joining pipe 53 to collectively flow toward the discharge pipe 6. That is, the joining pipe 53 is a pipe to which the exhaust gas flowing through each exhaust pipe 51a is joined. It is to be noted that the mode of the joining of the exhaust gas described above is described later.

The exhaust gas flowing through the joining pipe 53 flows from the back side toward the front side because the joining pipe 53 extends in the front-back direction. Accordingly, in the present embodiment, the front-back direction is also called a flow direction of the exhaust gas flowing through the joining pipe 53. In particular, the back side is also called an upstream side in the flow direction of the exhaust gas, and the front side is also called a downstream side in the flow direction of the exhaust gas.

The joining pipe 53 includes a plurality of guide portions 54. One guide portion 54 is provided for each flow pipe 51b. That is, in the present embodiment, six guide portions 54 are provided. Hereinafter, the configuration of the guide portion 54 is described.

### 3. Configuration of Guide Portion

FIG. 4 is a sectional view obtained by cutting the exhaust manifold 5 at a position taken along the line A-A′ of FIG. 3. FIG. 4 illustrates, as an example, the second exhaust manifold member 51-2 in an enlarged manner. It is to be noted that, as described above, in the present embodiment, the plurality of exhaust manifold members 51 have the same configuration, and hence the plurality of guide portions 54 have the same configuration.

The guide portion 54 is formed integrally with the flow pipe 51b inside the flow pipe 51b. That is, each guide portion 54 is formed integrally with the joining pipe 53. Specifically, the joining pipe 53 is a cast metal integrally including the plurality of guide portions 54.

For example, when each guide portion 54 is provided separately from the joining pipe 53, a fastening member such as a bolt for attaching each guide portion 54 to the joining pipe 53 is required, and the number of components of the exhaust manifold 5 increases. Thus, from the viewpoint of suppressing the increase in the number of components of the exhaust manifold 5, that is, manufacturing the exhaust manifold 5 with a small number of components, as in the present embodiment, each guide portion 54 is desirably formed integrally with the joining pipe 53.

The above-mentioned inside of the flow pipe 51b to which the guide portion 54 is provided is a flow passage 53a of the exhaust gas in the joining pipe 53 (flow pipe 51b). Thus, the guide portion 54 is positioned in the flow passage 53a of the exhaust gas of the joining pipe 53. In particular, the guide portion 54 is positioned to be opposed to an outlet 51a1 of the exhaust pipe 51a. That is, the plurality of guide portions 54 are provided (in the joining pipe 53) to respectively correspond to the plurality of exhaust pipes 51a.

The guide portion 54 is formed in a plate shape in which its back side extends in a direction of tilting leftward and downward with respect to the front-back direction. More specifically, the guide portion 54 has a back portion that is curved in a bulging manner toward the outlet 51a1 of the exhaust pipe 51a, and a front portion that is curved in a bulging manner to the opposite side of the back portion.

In the present embodiment, in the surface of the guide portion 54, a surface opposed to the outlet 51a1 of the exhaust pipe 51a is called an opposing surface 54S1. That is, each guide portion 54 is provided with the opposing surface 54S1 opposed to the outlet 51a1 of the corresponding exhaust pipe 51a. The opposing surface 54S1 is positioned from the back portion to the front portion of the guide portion 54, and hence is curved. That is, the opposing surface 54S1 is formed into a curved surface shape. It is to be noted that, in the surface of the guide portion 54, a surface on the opposite side of the opposing surface 54S1 is called an opposite surface 54S2. Similarly to the opposing surface 54S1, the opposite surface 54S2 is also formed into a curved surface shape.

When the opposing surface 54S1 is formed into the curved surface shape, as compared to a case in which the opposing surface 54S1 is formed into a flat surface shape, from the viewpoint of ensuring the strength of the guide portion 54 with respect to thermal expansion (of the guide portion 54), the case in which the opposing surface 54S1 is formed into the curved surface shape has more advantage. Thus, from the viewpoint of easily ensuring the strength of the guide portion 54 with respect to thermal expansion, as in the present embodiment, the opposing surface 54S1 is desirably formed into a curved surface shape.

On the most front side of the guide portion 54, a front end 54F is positioned, and, on the most back side, a back end 54B is positioned. In the present embodiment, the exhaust gas flowing through the joining pipe 53 flows from the back side toward the front side, and hence the front end 54F is also called a downstream end 54E1 and the back end 54B is also called an upstream end 54E2.

The front end 54F is positioned forward of the outlet 51a1 of the exhaust pipe 51a. Thus, in the present embodiment, the front ends 54F of all of the guide portions 54 are positioned forward of the outlets 51a1 of the corresponding exhaust pipes 51a. However, the front ends 54F of some guide portions 54 may be positioned above the outlets 51a1 of the corresponding exhaust pipes 51a. That is, at least one guide portion 54 has a part (in the present embodiment, the front end 54F) that is disposed on the downstream side (in the present embodiment, forward) in the flow direction of the exhaust gas flowing through the joining pipe 53, with respect to the outlet 51a1 of the corresponding exhaust pipe 51a.

The back end 54B is positioned on an orthogonal plane S that extends in the vertical direction, that is, that is orthogonal to the flow direction of the exhaust gas flowing through the joining pipe 53 (front-back direction). In particular, the orthogonal plane S is positioned to pass through a peripheral edge end 51a2 positioned on the most back side of the outlet 51a1 of the exhaust pipe 51a, that is, on the most upstream side in the flow direction of the exhaust gas flowing through the joining pipe 53. In other words, the peripheral edge end 51a2 is positioned on the orthogonal plane S similarly to the back end 54B. Thus, the upstream end 54E2 of each guide portion 54 is disposed on the orthogonal plane S that passes through the peripheral edge end 51a2 of the outlet 51a1 of the corresponding exhaust pipe 51a and is orthogonal to the flow direction of the exhaust gas (flowing through the joining pipe 53) (in the present embodiment, the front-back direction).

With the guide portion 54, the flow passage 53a of the exhaust gas in the joining pipe 53 is divided in a tilt direction in which the upper side is tilted rightward with respect to the up-down direction (see also FIG. 3). Specifically, the flow passage 53a is divided into a first flow passage 53a1 and a second flow passage 53a2 that are positioned side by side in the above-mentioned tilt direction. That is, each guide portion 54 divides the flow passage 53a of the exhaust gas in the joining pipe 53. It is to be noted that the present invention is not limited to the configuration in which the flow passage 53a is divided into two, and, for example, a configuration in which the flow passage 53a is divided into three or a configuration in which the flow passage 53a is divided into four or more may be employed.

The first flow passage 53a1 is gradually reduced in flow passage sectional area as directed from the upstream side to the downstream side (the back side to the front side) in the flow direction of the exhaust gas flowing through the joining pipe 53 due to the shape of the guide portion 54 described above. A first opening OP1 opened forward is positioned on the most front side of the first flow passage 53a1. A second opening OP2 opened forward is positioned on the most front side of the second flow passage 53a2.

The outlet 51a1 of the exhaust pipe 51a opened rightward and upward is connected to the second flow passage 53a2. Thus, the exhaust gas that has passed through the exhaust pipe 51a flows into the second flow passage 53a2 via the outlet 51a1. The exhaust gas that has flowed into the second flow passage 53a2 hits the opposing surface 54S1 and flows along the guide portion 54 (opposing surface 54S1). In this manner, the flow direction of the exhaust gas flowing through the second flow passage 53a2 approaches asymptotically to the front-back direction as the exhaust gas flows through the second flow passage 53a2. In detail, the downstream end 54E1 of the guide portion 54 is positioned on the downstream side (in the present embodiment, forward) in the flow direction of the exhaust gas flowing through the joining pipe 53 with respect to the outlet 51a1, and hence the flow direction of the exhaust gas flowing through the second flow passage 53a2 easily approaches asymptotically to the front-back direction.

Meanwhile, the exhaust gas flowing through the joining pipe 53 branches in the vicinity of the guide portion 54. Specifically, a part of the exhaust gas flowing through the joining pipe 53 flows into the second flow passage 53a2, and the remaining part thereof flows into the first flow passage 53a1. The exhaust gas that has flowed into the first flow passage 53a1 flows from the back side toward the front side along the guide portion 54 (opposite surface 54S2). The exhaust gas that has flowed into the second flow passage 53a2 flows along the guide portion 54 (opposing surface 54S1) together with the exhaust gas that has passed through the exhaust pipe 51a.

As a result, the exhaust gas that has passed through the first flow passage 53a1 and the exhaust gas that has passed through the second flow passage 53a2 separately flow into the coupling pipe 52 while flowing forward (flow directions are substantially aligned), and are joined at the coupling pipe 52. That is, at this time, the flow direction of the exhaust gas that has passed through the second flow passage 53a2 is substantially parallel with the flow direction of the exhaust gas that has passed through the first flow passage 53a1. That is, each guide portion 54 guides the exhaust gas flowing in from the corresponding exhaust pipe 51a into the flow direction of the exhaust gas flowing through the joining pipe 53 (in the present embodiment, the front-back direction).

With the above-mentioned configuration, when the exhaust gas flowing into the joining pipe 53 from the exhaust pipe 51a joins the exhaust gas flowing through the joining pipe 53, the flow directions thereof can be substantially aligned to one direction (in the present embodiment, forward). That is, the flow directions can be made parallel. In particular, a part of the guide portion 54 is positioned on the downstream side in the flow direction of the exhaust gas flowing through the joining pipe 53 with respect to the outlet 51a1 of the corresponding exhaust pipe 51a, and hence the flow directions can be made parallel easily. At the time of joining of the exhaust gas, as an angle formed between the flow direction of the exhaust gas on the joining side and the flow direction of the exhaust gas on the side to be joined is smaller, the flow disturbance is suppressed. Thus, with the above-mentioned flow directions being made parallel, it is possible to suppress the flow disturbance caused at the time of joining of the exhaust gas. This makes it possible to reduce the resistance caused by the above-mentioned flow disturbance (turbulence), and to promote gas replacement in each cylinder 21a (each combustion chamber). That is, in each cylinder 21a, the exhaust gas (gas after combustion) is less liable to remain, and intake air is liable to be loaded. Thus, as compared to a case having a large resistance by the above-mentioned flow disturbance, it is possible to achieve clean (fuel) combustion, and to enhance the thermal efficiency of the engine 1 and the cleanliness of the exhaust gas. As described above, it is possible to suppress the flow disturbance caused at the time of joining of the exhaust gas, improve the thermal efficiency of the engine 1, and enhance the cleanliness of the exhaust gas.

The degree of inflow of the exhaust gas flowing through the joining pipe 53 (flow passage 53a) into the second flow passage 53a2 changes depending on the state of the exhaust gas flowing into the second flow passage 53a2 from the exhaust pipe 51a. For example, when the exhaust gas flowing in from the exhaust pipe 51a has a relatively high pressure (high speed), the exhaust gas flowing through the joining pipe 53 is less liable to flow into the second flow passage 53a2. Meanwhile, when the exhaust gas flowing in from the exhaust pipe 51a has a relatively low pressure (low speed), the exhaust gas flowing through the joining pipe 53 easily flows into the second flow passage 53a2. Thus, the degree of inflow of the exhaust gas flowing through the joining pipe 53 into the second flow passage 53a2 changes depending on the state (in particular, the state of the pressure) of the exhaust gas flowing in from the exhaust pipe 51a, but the inflow is always allowed. Accordingly, even when the plurality of guide portions 54 are provided in the flow passage 53a of the exhaust gas of the joining pipe 53, the exhaust gas flowing through the joining pipe 53 (flow passage 53a) smoothly flows. In more detail, for the exhaust gas flowing through the joining pipe 53, with the installation of the guide portion 54, the first flow passage 53a1 provided separately from the second flow passage 53a2 is secured. Accordingly, even when the exhaust gas that has passed through each exhaust pipe 51a flows into the joining pipe 53, in particular, the second flow passage 53a2, the exhaust gas flowing through the joining pipe 53 is less liable to receive influence of the state (for example, the pressure) of the exhaust gas flowing into the second flow passage 53a2. Thus, from the viewpoint of ensuring (maintaining) smooth passage of the exhaust gas flowing through the joining pipe 53, as in the present embodiment, each guide portion 54 desirably divides the flow passage 53a of the exhaust gas in the joining pipe 53.

From the viewpoint of achieving both of the configuration in which the exhaust gas flowing in from the exhaust pipe 51a is guided in the flow direction of the exhaust gas flowing through the joining pipe 53 and the configuration in which the smooth passage of the exhaust gas flowing through the joining pipe 53 is ensured, the following configuration is desired. That is, as in the present embodiment, the upstream end 54E2 of each guide portion 54 is desirably disposed on the orthogonal plane S that passes through the peripheral edge end 51a2 of the outlet 51a1 of the corresponding exhaust pipe 51a and is orthogonal to the flow direction of the exhaust gas (flowing through the joining pipe 53).

It is to be noted that, as illustrated in FIG. 3, the downstream end 54E1 of the guide portion 54 is positioned to overlap a center line 53C of the joining pipe 53 as viewed from one side (in the present embodiment, the downstream side, that is, forward) in the flow direction of the exhaust gas flowing through the joining pipe 53. The center line 53C has the right side extending in a direction to tilt downward with respect to the right-left direction, and is completely orthogonal to the above-mentioned tilt direction (direction in which the upper side tilts rightward with respect to the up-down direction). However, the center line 53C is not limited to a configuration that is completely orthogonal to the tilt direction, and may be a configuration that, for example, slightly tilts and intersects with respect to the tilt direction. Examples of the center line 53C that slightly tilts with respect to the tilt direction include a center line 53C extending along the right-left direction.

As described above, the exhaust pipe 51a has a part extending rightward and upward toward the joining pipe 53 (flow pipe 51b). Thus, in the present embodiment, the downstream end 54E1 of each guide portion 54 is disposed to overlap the center line 53C orthogonal to the direction in which the corresponding exhaust pipe 51a extends toward the joining pipe 53 (in the present embodiment, the above-mentioned tilt direction) as viewed from one side in the flow direction of the exhaust gas flowing through the joining pipe 53. However, the downstream ends 54E1 of some guide portions 54 may be disposed in a shifted manner with respect to the center line 53C as viewed from a direction similar to the above. That is, the downstream end 54E1 of at least one guide portion 54 is disposed to overlap the center line 53C orthogonal to the direction in which the corresponding exhaust pipe 51a extends toward the joining pipe 53 as viewed from one side in the flow direction of the exhaust gas (flowing through the joining pipe 53).

In this manner, the opening area of the first opening OP1 and the opening area of the second opening OP2 become the same. That is, at the position (on the most front side of the guide portion 54) at which the downstream end 54E1 is disposed in the flow direction of the exhaust gas flowing through the joining pipe 53, the flow passage 53a is equally divided into two. Thus, from the viewpoint of easily achieving a configuration in which at least one of the plurality of guide portions 54 equally divides the inside of the joining pipe 53 into two at the position in which the downstream end 54E1 (of the guide portion 54 itself) is disposed in the flow direction of the exhaust gas flowing through the joining pipe 53, the following configuration is desired. That is, as in the present embodiment, the downstream end 54E1 in at least one guide portion 54 is desirably disposed to overlap the center line 53C of the joining pipe 53 orthogonal to the direction in which the corresponding exhaust pipe 51a extends toward the joining pipe 53, as viewed from one side in the flow direction.

However, the exhaust manifold 5 is not limited to a configuration in which the opening area of the first opening OP1 and the opening area of the second opening OP2 are the same. For example, the exhaust manifold 5 may have a configuration in which the opening area of the first opening OP1 and the opening area of the second opening OP2 are different. An area ratio between the opening area of the first opening OP1 and the opening area of the second opening OP2 may be set based on a flow ratio between the flow rate of the exhaust gas flowing through the joining pipe 53 and the flow rate of the exhaust gas flowing through each exhaust pipe 51a.

Further, in any one of the configurations in which the opening area of the first opening OP1 and the opening area of the second opening OP2 are the same and different, the downstream end 54E1 is not limited to a configuration of being disposed to overlap the center line 53C as viewed from one side in the flow direction of the exhaust gas flowing through the joining pipe 53. For example, the downstream end 54E1 may have a configuration in which a middle portion thereof is positioned in a shifted manner rightward and upward (or leftward and downward) with respect to the center line 53C as viewed from a direction similar to the above. Specifically, the downstream end 54E1 may have a curved shape (or protruding shape).

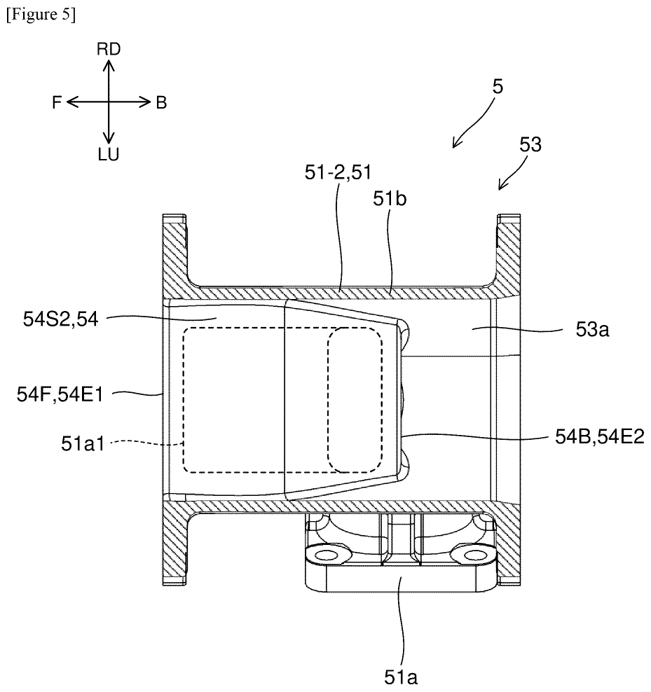

Here, the disposing position of the guide portion 54 when the guide portion 54 is viewed from a direction opposed to the outlet 51a1 of the exhaust pipe 51a (upper right in the present embodiment) is described with reference to FIG. 5. FIG. 5 is a sectional view obtained by cutting the exhaust manifold 5 at a position taken along the line B-B′ of FIG. 3. FIG. 5 illustrates, similarly to FIG. 4, as an example, the second exhaust manifold member 51-2 in an enlarged manner.

The guide portion 54 is positioned to block the outlet 51a1 when the guide portion 54 is viewed from a direction opposed to the outlet 51a1 of the exhaust pipe 51a. In other words, the entire outlet 51a1 is positioned to overlap the guide portion 54. That is, each guide portion 54 covers the outlet 51a1 as viewed from the direction opposed to the outlet 51a1 of the corresponding exhaust pipe 51a (upper right in the present embodiment).

From the viewpoint of reliably achieving the configuration in which the exhaust gas flowing in from the exhaust pipe 51a is guided in the flow direction of the exhaust gas flowing through the joining pipe 53, the following configuration is desired. That is, as in the present embodiment, each guide portion 54 desirably covers the outlet 51a1 (of the corresponding exhaust pipe 51a) as viewed from the direction that is opposed to the outlet 51a1 of the corresponding exhaust pipe 51a.

### 4. Modification Example of Guide Portion

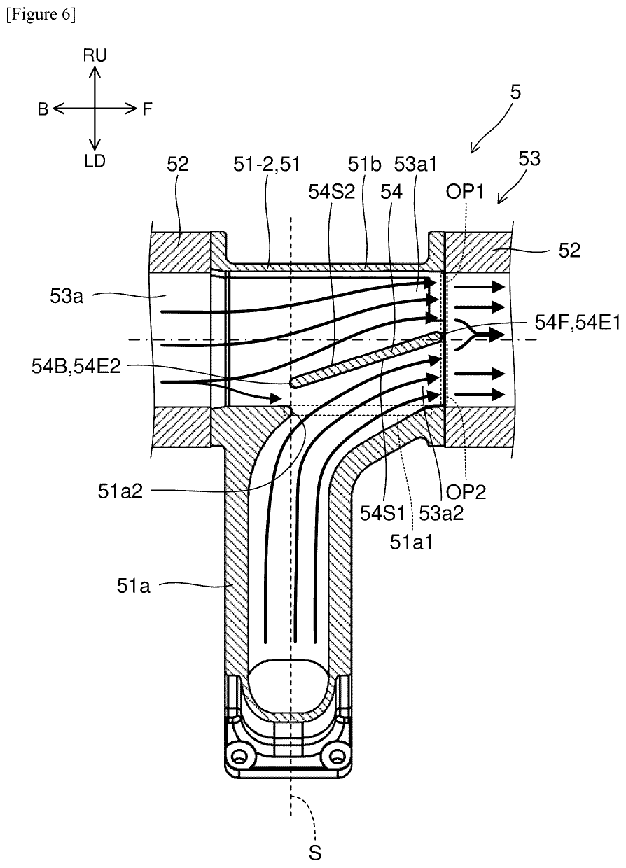

A configuration of a modification example of the guide portion 54 is described with reference to FIG. 6. FIG. 6 is a sectional view illustrating the configuration of the modification example of the guide portion 54. The exhaust manifold 5 illustrated in FIG. 6 is a configuration similar to the exhaust manifold 5 illustrated in FIG. 4 or the like except that the opposing surface 54S1 is formed into a flat surface shape.

The guide portion 54 is formed into a flat plate shape in which its back side extends in a direction of tilting downward with respect to the front-back direction. Thus, the opposing surface 54S1 is formed into a flat surface shape. It is to be noted that, similarly to the opposing surface 54S1, the opposite surface 54S2 is also formed into a flat surface shape.

From the viewpoint of simplifying the guide portion 54 to easily manufacture the guide portion 54, as in the modification example, the opposing surface 54S1 is desirably formed into a flat surface shape.

### 5. Supplement

In the present embodiment, the case in which the engine 1 has a series-type configuration in which the cylinders 21a are provided side by side in one row in the front-back direction has been described, but the engine 1 may have, for example, a V-shaped configuration.

In the present embodiment, the case in which the engine 1 is configured of a diesel engine using light oil as fuel has been described, but the engine 1 may be configured of, for example, a gasoline engine.

In the present embodiment, the case in which the exhaust manifold 5 is configured to be divisible has been described, but the exhaust manifold 5 may be configured to be indivisible. For example, the exhaust manifold 5 may be configured to integrally include the plurality of exhaust manifold members 51 and the plurality of coupling pipes 52.

### 6. Clauses

The engine 1 and the exhaust manifold 5 described in the present embodiment can also be expressed as an engine and an exhaust manifold represented in the following clauses.
An exhaust manifold of clause (1) is
   an exhaust manifold of an engine including a plurality of cylinders, the exhaust manifold including:
      a plurality of exhaust pipes through each of which an exhaust gas discharged from each of the cylinders flows; and
      a joining pipe coupled to the plurality of exhaust pipes, to which the exhaust gas flowing through each of the exhaust pipes is joined,
      in which the joining pipe includes a plurality of guide portions provided to respectively correspond to the plurality of exhaust pipes,
      in which each of the guide portions guides the exhaust gas flowing in from the corresponding exhaust pipe in a flow direction of the exhaust gas flowing through the joining pipe,
      in which each of the guide portions has an opposing surface provided to be opposed to an outlet of the corresponding exhaust pipe, and
      in which at least one of the guide portions has a part that is disposed on a downstream side in the flow direction with respect to the outlet.
An exhaust manifold of clause (2) is the exhaust manifold according to clause (1),
   in which each of the guide portions divides a flow passage of the exhaust gas in the joining pipe.
An exhaust manifold of clause (3) is the exhaust manifold according to clause (1) or (2),
   in which each of the guide portions covers the outlet as viewed from a direction that is opposed to the outlet of the corresponding exhaust pipe.
An exhaust manifold of clause (4) is the exhaust manifold according to any one of clauses (1) to (3),
   in which an upstream end on an upstream side in the flow direction in each of the guide portions is disposed on an orthogonal plane that passes through a peripheral edge end on the upstream side in the flow direction in the outlet of the corresponding exhaust pipe and is orthogonal to the flow direction.
An exhaust manifold of clause (5) is the exhaust manifold according to any one of clauses (1) to (4),
   in which a downstream end on the downstream side in the flow direction in at least one of the guide portions is disposed to overlap a center line of the joining pipe orthogonal to a direction in which the corresponding exhaust pipe extends toward the joining pipe as viewed from one side in the flow direction.
An exhaust manifold of clause (6) is the exhaust manifold according to any one of clauses (1) to (5),
   in which the opposing surface is formed into a curved surface shape.
An exhaust manifold of clause (7) is the exhaust manifold according to any one of clauses (1) to (5),
   in which the opposing surface is formed into a flat surface shape.
An exhaust manifold of clause (8) is the exhaust manifold according to any one of clauses (1) to (7),
   in which each of the exhaust pipes is disposed in the same orientation.
An exhaust manifold of clause (9) is the exhaust manifold according to any one of clauses (1) to (8),
   in which each of the guide portions is formed integrally with the joining pipe.
An engine of clause (10) includes:
   a plurality of cylinders; and
   the exhaust manifold according to any one of clauses (1) to (9).

The embodiment of the present invention has been described above, but the scope of the present invention is not limited thereto, and expansion and changes can be made without departing from the gist of the invention.

### INDUSTRIAL APPLICABILITY

The present invention is applicable to an engine to be used in, for example, a working machine (such as an agricultural machine or a construction machine), a vessel, and a power generation device.

### REFERENCE SIGNS LIST

1 . . . engine
5 . . . exhaust manifold
21a . . . cylinder
51a . . . exhaust pipe
51a1 . . . outlet
51a2 . . . peripheral edge end
53 . . . joining pipe
53C . . . center line
53a . . . flow passage
54 . . . guide portion
54E1 . . . downstream end
54E2 . . . upstream end
54S1 . . . opposing surface
S . . . orthogonal plane

1. An exhaust manifold of an engine including a plurality of cylinders, the exhaust manifold comprising:
a plurality of exhaust pipes through each of which an exhaust gas discharged from each of the cylinders flows; and
a joining pipe coupled to the plurality of exhaust pipes, to which the exhaust gas flowing through each of the exhaust pipes is joined,
wherein the joining pipe includes a plurality of guide portions provided to respectively correspond to the plurality of exhaust pipes,
wherein each of the guide portions guides the exhaust gas flowing in from the corresponding exhaust pipe in a flow direction of the exhaust gas flowing through the joining pipe,
wherein each of the guide portions has an opposing surface provided to be opposed to an outlet of the corresponding exhaust pipe, and
wherein at least one of the guide portions has a part that is disposed on a downstream side in the flow direction with respect to the outlet.

2. The exhaust manifold according to claim 1, wherein each of the guide portions divides a flow passage of the exhaust gas in the joining pipe.

3. The exhaust manifold according to claim 1, wherein each of the guide portions covers the outlet as viewed from a direction that is opposed to the outlet of the corresponding exhaust pipe.

4. The exhaust manifold according to claim 1, wherein an upstream end on an upstream side in the flow direction in each of the guide portions is disposed on an orthogonal plane that passes through a peripheral edge end on the upstream side in the flow direction in the outlet of the corresponding exhaust pipe and is orthogonal to the flow direction.

5. The exhaust manifold according to claim 1, wherein a downstream end on the downstream side in the flow direction in at least one of the guide portions is disposed to overlap a center line of the joining pipe orthogonal to a direction in which the corresponding exhaust pipe extends toward the joining pipe as viewed from one side in the flow direction.

6. The exhaust manifold according to claim 1, wherein the opposing surface is formed into a curved surface shape.

7. The exhaust manifold according to claim 1, wherein the opposing surface is formed into a flat surface shape.

8. The exhaust manifold according to claim 1, wherein each of the exhaust pipes is disposed in the same orientation.

9. The exhaust manifold according to claim 1, wherein each of the guide portions is formed integrally with the joining pipe.

10. An engine comprising:
a plurality of cylinders; and
the exhaust manifold according to claim 1.
